(19) United States
(12) Patent Application Publication
(10) Pub. No.: US 2026/0120048 A1
(43) Pub. Date: Apr. 30, 2026

(54) TRANSPORTATION PLANNING APPARATUS AND TRANSPORTATION PLANNING METHOD

(71) Applicant: Hitachi, Ltd., Tokyo (JP)

(72) Inventors: Akane SETO, Tokyo (JP); Naoko MIYASHITA, Tokyo (JP); Kazuya UYAMA, Tokyo (JP)

(21) Appl. No.: 19/324,313

(22) Filed: Sep. 10, 2025

(30) Foreign Application Priority Data
Oct. 29, 2024 (JP) 2024-189520

(51) Int. Cl. G06Q 10/083

(52) U.S. Cl. CPC G06Q 10/0838

(57) ABSTRACT

A transportation planning portion formulates a transportation plan on the basis of transportation conditions of the transportation plan, which is a formulation target, past transportation conditions, and weights of the important achievement evaluation indicators of actual transportation records and an indicator estimation portion estimates weights of important achievement evaluation indicators relative to the past transportation conditions by comparing values of the important achievement evaluation indicators calculated on the basis of the transportation plan formulated by the transportation planning portion with values of the important achievement evaluation indicators of past actual transportation records calculated from the past actual transportation records; and an indicator setting portion that identifies, from among a plurality of the past transportation conditions, past transportation conditions with the highest similarity to the transportation conditions of the transportation plan, which is the formulation target, and sets weights of the important achievement evaluation indicators of the actual transportation record.

### CROSS-REFERENCE TO PRIOR APPLICATION

This application relates to and claims the benefit of priority from Japanese Patent Application number 2024-189520, filed on October 29, 2024 the entire disclosure of which is incorporated herein by reference.

### BACKGROUND

The present invention relates to a transportation planning apparatus, a transportation planning method, and a transportation planning program, and is suitably applicable to, for example, a transportation planning apparatus related to a technique for formulating a transportation plan.

In the logistics industry, in order to address the shortage of drivers due to issues such as the so-called "2024 problem" in Japan, it is required to reduce the number of required drivers by improving transportation efficiency and to retain driver workforce by enhancing the quality of work (QoW) for each driver. There is a trade-off between reducing the number of required drivers and enhancing the QoW for drivers. Therefore, the favorable balance between these two varies, depending on transportation operators and characteristics of the targeted transportation (hereinafter referred to as "transportation characteristics"). Japanese Patent Application Publication No. 2023-54652 discloses a technique for determining, on the basis of a plan requiring modification and freely-selected key performance indicators (KPI) priority information, a plan organization proposal to maximize a predefined objective function, by using a plan organization proposal restriction model that is trained by machine learning, with learning data serving as training data.

### SUMMARY

However, reducing the number of required drivers and enhancing the QoW for drivers are in a trade-off relationship. The technique described in Japanese Patent Application Publication No. 2023-54652 faces difficulties in formulating a favorable transportation plan for transportation operators and transportation characteristics while considering the balance between the above-mentioned two factors.

The present invention has been made in consideration of the above points, and aims to propose a transportation planning apparatus and a transportation planning method capable of formulating a favorable transportation plan for transportation operators and transportation characteristics by achieving a balance between reducing the number of required drivers and enhancing the QoW for drivers.

To solve this problem, the present invention includes: a transportation planning portion that formulates a transportation plan on the basis of transportation conditions of the transportation plan, which is a formulation target, past transportation conditions, and weights of important achievement evaluation indicators of actual transportation records; an indicator estimation portion that estimates weights of the important achievement evaluation indicators relative to the past transportation conditions by comparing values of the important achievement evaluation indicators calculated on the basis of the transportation plan formulated by the transportation planning portion with values of the important achievement evaluation indicators of past actual transportation records calculated from the past actual transportation records; and an indicator setting portion that identifies, from among a plurality of the past transportation conditions, past transportation conditions with the highest similarity to the transportation conditions of the transportation plan, which is the formulation target, and sets the weights of the important achievement evaluation indicators of the actual transportation records corresponding to the identified past transportation conditions.

The present invention further includes: a transportation planning step, in which a transportation planning portion formulates a transportation plan on the basis of transportation conditions of the transportation plan, which is a formulation target, past transportation conditions, and weights of important achievement evaluation indicators of actual transportation records; an important achievement evaluation indicator estimation step, in which an indicator estimation portion calculates weights of the important achievement evaluation indicators relative to the past transportation conditions by comparing values of the important achievement evaluation indicators calculated on the basis of the transportation plan formulated by the transportation planning portion with values of the important achievement evaluation indicators of past actual transportation records calculated from the past actual transportation records; and an important achievement evaluation indicator setting step, in which an indicator setting portion identifies, from among a plurality of the past transportation conditions, past transportation conditions with the highest similarity to the transportation conditions of the transportation plan, which is the formulation target, and sets the weights of the important achievement evaluation indicators of the actual transportation records corresponding to the identified past transportation conditions.

In addition, in the present invention, the following steps are executed on a computer: a transportation planning step, in which a transportation planning portion is caused to formulate a transportation plan on the basis of transportation conditions of the transportation plan, which is a formulation target, past transportation conditions, and weights of important achievement evaluation indicators of actual transportation records; a calculation step, in which an indicator estimation portion is caused to calculate weights of the important achievement evaluation indicators relative to the past transportation conditions by comparing values of the important achievement evaluation indicators calculated on the basis of the transportation plan formulated by the transportation planning portion with values of the important achievement evaluation indicators of past actual transportation records calculated from the past actual transportation records; and a setting step, in which an indicator setting portion is caused to identify, from among a plurality of the past transportation conditions, past transportation conditions with the highest similarity to the transportation conditions of the transportation plan, which is the formulation target, and set the weights of the important achievement evaluation indicators of the actual transportation records corresponding to the identified past transportation conditions.

According to the present invention, it is possible to formulate a favorable transportation plan for transportation operators and transportation characteristics by achieving a balance between reducing the number of required drivers and enhancing the QoW for drivers.

### BRIEF DESCRIPTION OF THE DRAWINGS

FIG. 1 is a system configuration diagram showing an example of the hardware configuration of a transportation planning system including a transportation planning apparatus according to the present embodiment;

FIG. 2 is a system configuration diagram showing an example of the software configuration of the transportation planning system including the transportation planning apparatus and a database apparatus shown in FIG. 1;

FIG. 3 is a diagram showing an example of a function for estimating KPI weights;

FIG. 4 is a diagram showing an example of a function for estimating KPI weights of transportation conditions of actual transportation records of the formulation target;

FIG. 5 is a diagram showing an example of order information;

FIG. 6 is a diagram showing an example of vehicle information;

FIG. 7 is a diagram showing an example of driver information;

FIG. 8 is a diagram showing an example of KPI weight information;

FIG. 9 is a diagram showing an example of actual transportation record information;

FIG. 10 is a diagram showing an example of past transportation condition information;

FIG. 11 is a diagram showing an example of base information;

FIG. 12 is a diagram showing an example of inter-base movement information;

FIG. 13 is a flowchart showing an example of the procedure for transportation planning processing; and

FIG. 14 is a diagram showing an example of a transportation plan output screen displayed on a display apparatus.

### DESCRIPTION OF THE PREFERRED EMBODIMENTS

Hereinafter, an embodiment of the present invention will be described in detail with reference to the drawings.

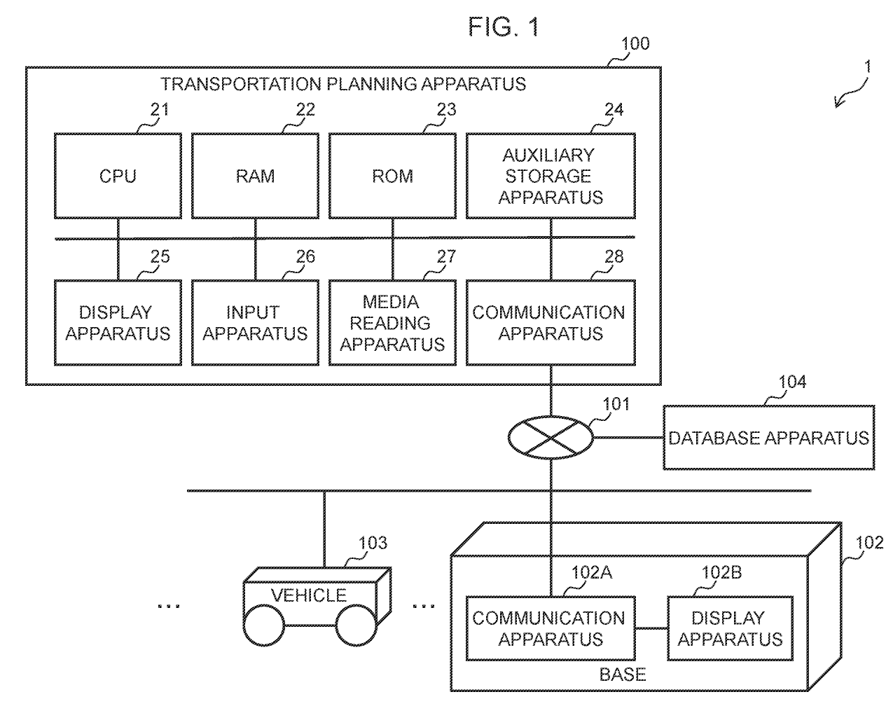

FIG. 1 is a system configuration diagram showing an example of the hardware configuration of a transportation planning system 1 including a transportation planning apparatus 100 according to the present embodiment.

The transportation planning system 1 includes the transportation planning apparatus 100, at least one vehicle 103, a plan management terminal 102, a database apparatus 104, and a network 101. The transportation planning apparatus 100, at least one vehicle 103, and the plan management terminal 102 are connected to each other via the network 101 and have a function of exchanging data and commands with each other. The vehicle 103 is connected to the network 101 wirelessly, for example. The database apparatus 104 will be described later.

The transportation planning apparatus 100 is, for example, a computer. The transportation planning apparatus 100 includes a central processing unit (CPU) 21, a random access memory (RAM) 22, a read only memory (ROM) 23, an auxiliary storage apparatus 24, a display apparatus 25, an input apparatus 26, a media reading apparatus 27, and a communication apparatus 28. A transportation planning program, which will be described later, operates in the transportation planning apparatus 100. The transportation planning program may be recorded on a non-transitory computer-readable recording medium.

The auxiliary storage apparatus 24 is a large-capacity storage apparatus that stores the transportation planning program in addition to data in a non-volatile manner. The ROM 23 is a storage apparatus that stores data and the like in a non-volatile manner. The ROM 23 may store the transportation planning program instead of the auxiliary storage apparatus 24.

The RAM 22 is a volatile storage apparatus that temporarily stores data and programs such as the transportation planning program. The CPU 21 controls the entire transportation planning apparatus 100. The CPU 21 reads the transportation planning program from the auxiliary storage apparatus 24, stores same in the RAM 22, and controls the execution of the transportation planning program. Details of the transportation planning program will be described later.

The display apparatus 25 can exemplify a transportation plan output screen, which will be described later, as the display target to be shown on the display apparatus 25 that displays the input and output content by means of the transportation planning program. The input apparatus 26 is an operation device such as a keyboard or a mouse that accepts the input content from the outside. The media reading apparatus 27 has a function of reading data and the like from various types of media. Under the control of the CPU 21, the communication apparatus 28 controls communication with the outside, such as the vehicle 103, the plan management terminal 102, and the database apparatus 104, via the network 101.

The vehicle 103 starts moving from an initial base, stops over in at least one base on a predetermined route, and finally returns to the initial base.

The plan management terminal 102 is arranged at the at least one base where the vehicle 103 traveling along the predetermined route stops over. The plan management terminal 102 includes a communication apparatus 102A and a display apparatus 102B. The communication apparatus 102A has a function of exchanging data and commands with the communication apparatus 28 of the transportation planning apparatus 100 via the network 101. The display apparatus 102B has a function of performing display on the basis of data acquired from the transportation planning apparatus 100.

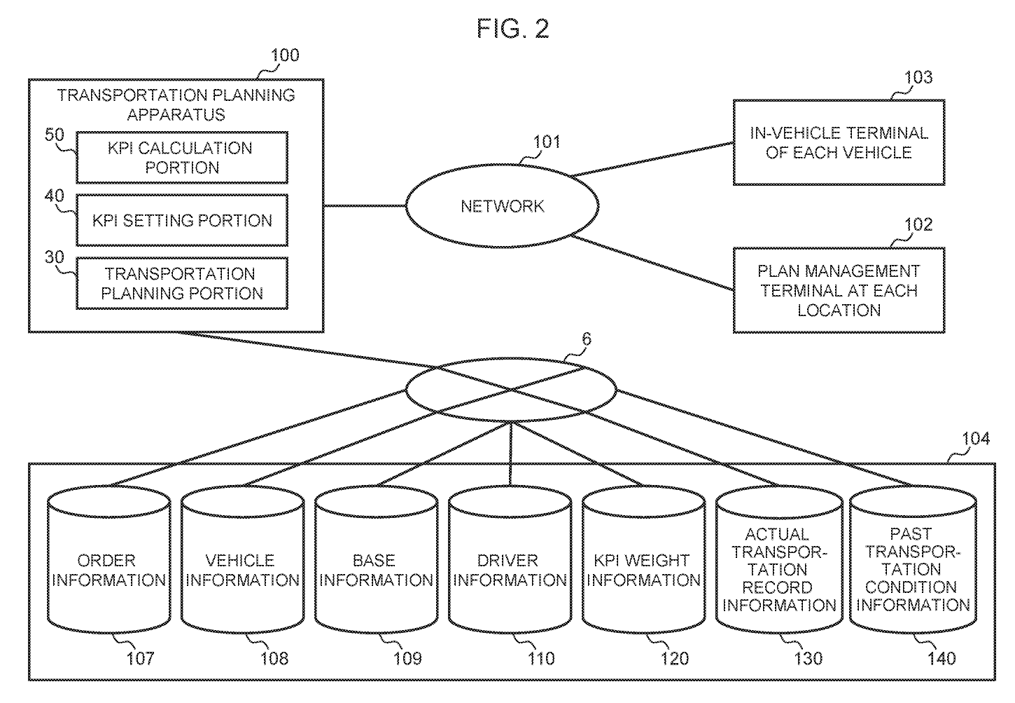

FIG. 2 is a system configuration diagram showing an example of the software configuration of the transportation planning system 1 including the transportation planning apparatus 100 and the database apparatus 104 shown in FIG. 1. Note that each piece of information held by the database apparatus 104 may alternatively be held by the transportation planning apparatus 100 instead.

The transportation planning apparatus 100 is, for example, a computer on which the transportation planning program operates, and includes a transportation planning portion 30, a KPI setting portion 40, and a KPI calculation portion 50. An overview of the transportation planning portion 30, the KPI setting portion 40, and the KPI calculation portion 50 will be described.

The transportation planning portion 30 formulates a transportation plan on the basis of transportation conditions of the transportation plan, which is the formulation target, past transportation conditions, and weights of key performance indicators (KPIs) (serving as an example of important achievement evaluation indicators) of actual transportation records.

The KPI calculation portion 50, which serves as an example of an indicator estimation portion, calculates KPI weights relative to the past transportation conditions by comparing the KPI values calculated on the basis of the transportation plan formulated by the transportation planning portion 30 with the KPI values of past actual transportation records calculated from the past actual transportation records.

The KPI setting portion 40, which serves as an example of an indicator setting portion, identifies, from among a plurality of the past transportation conditions, the past transportation conditions with the highest similarity to the transportation conditions of the transportation plan, which is the formulation target, and sets KPI weights of the actual transportation records corresponding to the identified past transportation conditions. Details of the KPI calculation portion 50 will be described later.

In other words, the above-mentioned transportation planning program executes the following steps on a computer: a transportation planning step, in which the above-mentioned transportation planning portion 30 is caused to formulate a transportation plan on the basis of transportation conditions of the transportation plan, which is the formulation target, past transportation conditions, and KPI weights of actual transportation records; a calculation step, in which the KPI calculation portion 50 is caused to calculate KPI weights relative to the past transportation conditions by comparing the KPI values calculated on the basis of the transportation plan formulated by the transportation planning portion 30 with the KPI values of past actual transportation records calculated from the past actual transportation records; and a setting step, in which the KPI setting portion 40 is caused to identify, from among a plurality of the past transportation conditions, the past transportation conditions with the highest similarity to the transportation conditions of the transportation plan, which is the formulation target, and set weights of the important achievement evaluation indicators of the actual transportation records corresponding to the identified past transportation conditions.

The database apparatus 104 includes order information 107, vehicle information 108, base information 109, driver information 110, actual transportation record information 130, and past transportation condition information 140. The database apparatus 104 includes inter-base movement information, which will be described later. The inter-base movement information is acquired by means of arithmetic from at least a partial combination of the plurality of pieces of information. Details of the order information 107, the vehicle information 108, the base information 109, the driver information 110, the actual transportation record information 130, and the past transportation condition information 140 will be described later.

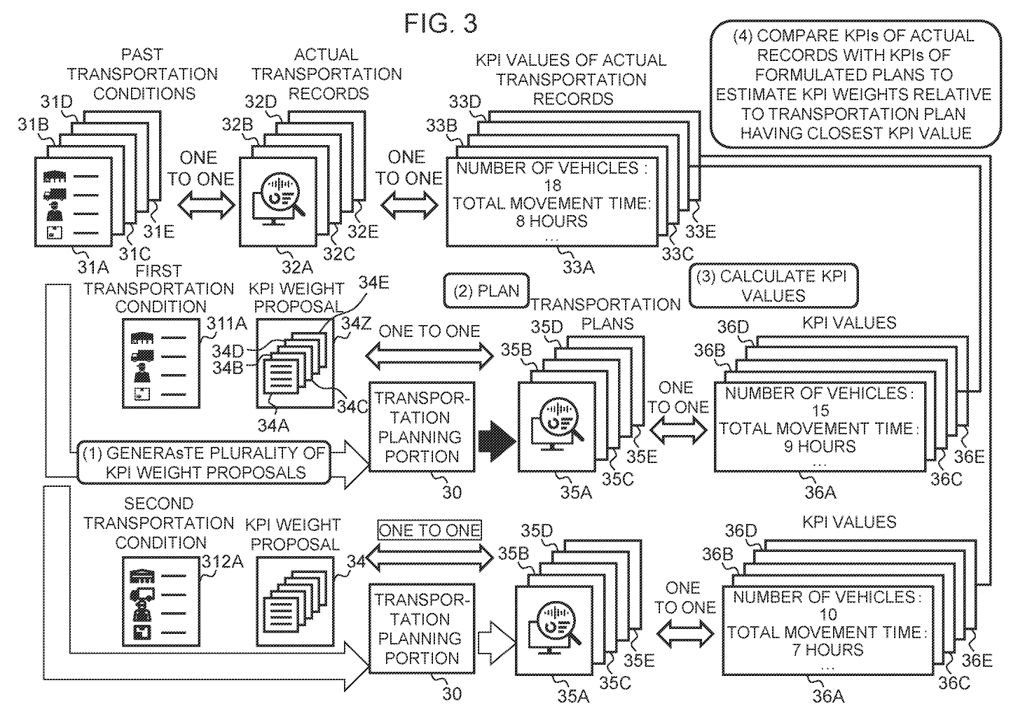

FIG. 3 is a diagram showing an example of a function for estimating KPI weights. In the present embodiment, the appropriate weighting of KPIs relative to the transportation conditions of the transportation plan, which is the formulation target, is unknown and is to be obtained, however, it is assumed that there are a plurality of pre-prepared actual transportation records 32A to 32E, which are appropriate KPIs, and the KPI values of the actual transportation records.

In the present embodiment, the KPI values 33A to 33E of a plurality of the actual transportation records, each corresponding to the plurality of the actual transportation records 32A to 32E that respectively correspond to the past transportation conditions 31A to 31E are prepared in advance.

Here, the KPI calculation portion 50 generates a KPI weight proposal including a plurality of KPI weights 34A to 34E on the basis of a first transportation condition 311A, and inputs same to the transportation planning portion 30.

The transportation planning portion 30 identifies, from among a plurality of transportation plans 35A to 35E, the transportation plan 35D corresponding to the first transportation condition 311A and specific KPI weights among the plurality of KPI weights. The KPI value 36E corresponding to the transportation plan 35D is estimated from among a plurality of the KPI values 36A to 36E.

The KPI calculation portion 50 thus estimates the KPI weights of the past transportation conditions by comparing the KPI values (e.g., the KPI value 33A) calculated on the basis of the transportation plan formulated by the transportation planning portion 30 on the basis of the past transportation conditions and the like, with the estimated the KPI value 36E. The same processing applies to the second transportation condition 312A.

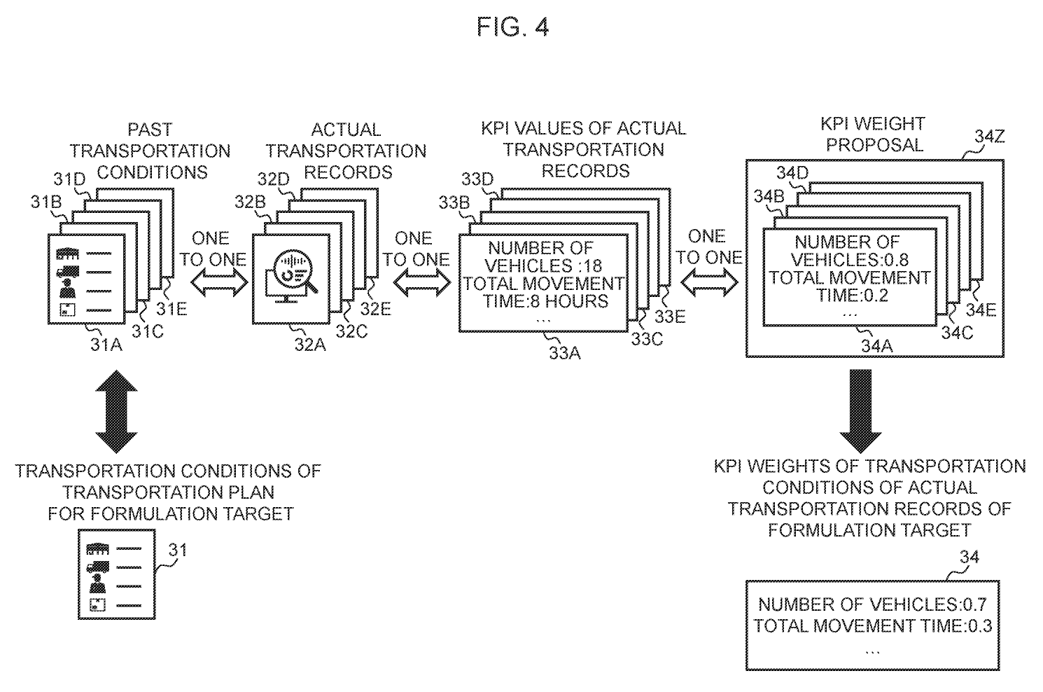

FIG. 4 is a diagram showing an example of a function for estimating KPI weights of transportation conditions of the actual transportation records of the formulation target. In the present embodiment, the appropriate weighting of KPIs relative to the transportation conditions of the transportation plan, which is the formulation target, is unknown and is to be obtained, however, it is assumed that there are a plurality of pre-prepared actual transportation records 32A to 32E, which are appropriate KPIs.

The KPI calculation portion 50 identifies, from among the past transportation conditions 31A to 31E, the past transportation condition 31B with the highest similarity to the transportation condition 31 of the transportation plan, which is the formulation target. The KPI calculation portion 50 identifies, from among a plurality of the actual transportation records 32A to 32E, the actual transportation record 32B corresponding to the past transportation condition 31B with the highest similarity.

The KPI calculation portion 50 calculates the plurality of KPI weights 34A to 34E, each corresponding to the KPI values 33A to 33E of the plurality of the actual transportation records that are respectively calculated from the plurality of the actual transportation records 32A to 32E. In the illustrated example, the plurality of KPI weights 34A to 34E are represented as the KPI weight proposal 34Z. The KPI calculation portion 50 identifies, from among the plurality of KPI weights 34A to 34E included in the KPI weight proposal 34Z, the KPI weight 34B of the transportation conditions of the transportation plan, which is the formulation target, corresponding to the past transportation condition 31B with the highest similarity, and estimates the KPI weights 34 of the transportation conditions of the actual transportation records of the formulation target corresponding to the KPI weight 34B.

The present embodiment has the following advantages over, for example, so-called artificial intelligence in terms of estimating KPI weights. First, estimating KPI weights using artificial intelligence is, in a sense, a black box, and the basis for estimation is unclear, but according to the method of the present embodiment, the basis for estimation of KPI weights is easy to understand. Second, since the similarity of transportation conditions is specifically exemplified, it is possible to prevent KPI weights from being estimated arbitrarily.

The transportation planning portion 30 formulates a transportation plan on the basis of the set KPI weights of the actual transportation records and the transportation conditions of the transportation plan, which is the formulation target.

The transportation planning portion 30 extracts the transportation conditions of the transportation plan, which is the formulation target, and the past transportation conditions, from at least one of the following: the order information, the vehicle information, the driver information, and the base information.

The above-mentioned KPI weights include at least one item from the following: minimization of the number of vehicles, minimization of the number of drivers, maximization of loading rate, minimization of pickup and delivery time window violations, minimization of working time window violations, leveling of drivers' working hours, leveling of the number of drivers' visits, and leveling of loading rate; and the corresponding weights of each of the above-mentioned at least one item.

The KPI setting portion 40 estimates the past transportation conditions from the past actual transportation records. The KPI setting portion 40 determines the similarity of the transportation conditions on the basis of at least one of the following: total number of orders, total order quantity, total order quantity relative to total vehicle loading capacity, length of order shipping time windows, length of order delivery time windows, distribution of order shipping time windows, distribution of order delivery time windows, length of order shipping time windows relative to length of vehicle operation time windows, length of order delivery time windows relative to length of vehicle operation time windows, length of order shipping time windows relative to length of time required for shipping work, length of order delivery time windows relative to length of time required for delivery work, number of vehicles, vehicle loadable capacity, length of vehicle operation time windows, distribution of vehicle operation time windows, number of drivers, length of driver working time windows, distribution of driver working time windows, number of bases, latitude and longitude of bases, distribution of bases, distance between bases, and inter-base movement time.

The KPI calculation portion 50 identifies a plurality of the past transportation conditions with a high similarity to the transportation conditions of the transportation plan, which is the formulation target, and calculates, by performing statistical processing on the KPI weights of a plurality of the actual transportation records corresponding to the plurality of identified past transportation conditions, the KPI weights of the transportation conditions of the transportation plan, which is the formulation target.

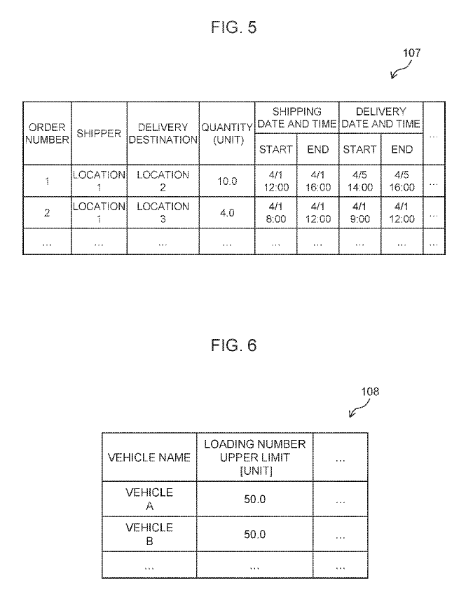

FIG. 5 is a diagram showing an example of the order information 107. The order information 107 manages, for example, order number, shipper, delivery destination, quantity, shipping date and time, and delivery date and time. The shipping date and time includes start date and time and end date and time. The delivery date and time includes start date and time and end date and time.

FIG. 6 is a diagram showing an example of the vehicle information 108. The vehicle information 108 manages vehicle name and loading number upper limit related to each vehicle 103. The vehicle information 108 may also include, as other information related to each vehicle 103, for example, information related to the license plate of each vehicle 103 and information indicating whether each vehicle 103 is an electric vehicle, gasoline-powered vehicle, hybrid vehicle, or hydrogen engine vehicle.

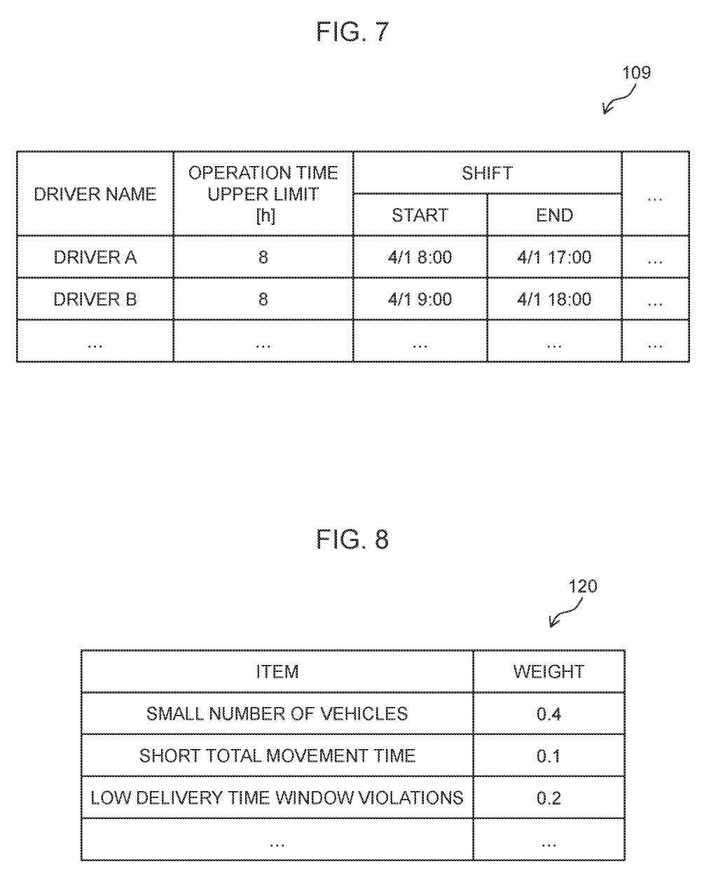

FIG. 7 is a diagram showing an example of the driver information 110. The driver information 110 manages, for example, driver name, operation time upper limit, and shift. The shift includes the start date and time and the end date and time. FIG. 8 is a diagram showing an example of the KPI weight information 120. The KPI weight information 120 manages, for example, item and KPI weight.

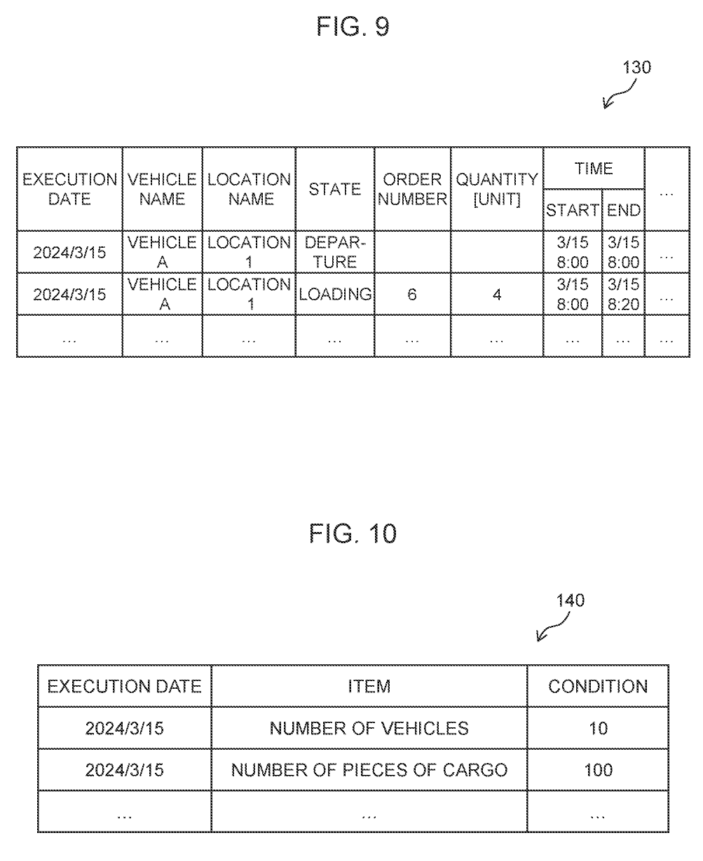

FIG. 9 is a diagram showing an example of the actual transportation record information 130. The actual transportation record information 130 manages items such as execution date, vehicle name, location name, status, order number, quantity, and time. The time includes the start date and time and the end date and time.

FIG. 10 is a diagram showing an example of the past transportation condition information 140. The past transportation condition information 140 manages past transportation conditions. The past transportation condition information 140 manages, for example, execution date, item, and condition.

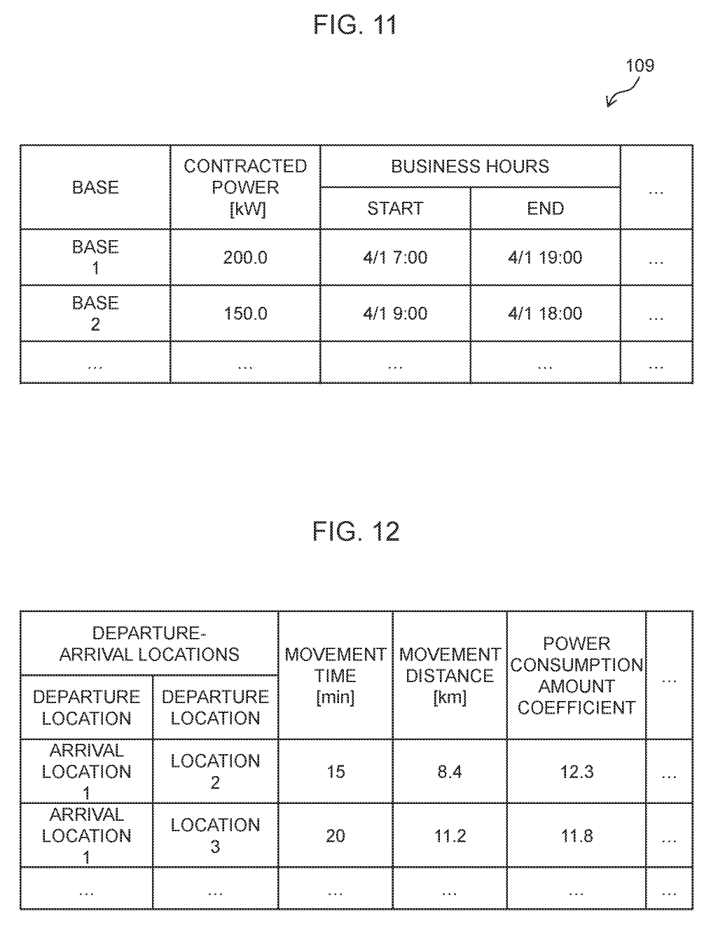

FIG. 11 is a diagram showing an example of the base information 109. The base information 109 manages information related to bases where at least the vehicle 103 is charged. The base information 109 manages, for example, base, contracted power, and business hours. Business hours include the start date and time and the end date and time.

FIG. 12 is a diagram showing an example of inter-base movement information. The inter-base movement information manages departure-arrival locations, movement time, movement distance, and power consumption amount. Departure-arrival locations include the departure location and the arrival location of the vehicle 103.

The transportation planning system 1 including the transportation planning apparatus 100 according to the present embodiment has the configuration described above. Next, an example of a transportation planning method using the transportation planning system 1 including the transportation planning apparatus 100 will be described. The transportation planning method includes: a transportation planning step, in which the transportation planning portion 30 formulates a transportation plan on the basis of transportation conditions of the transportation plan, which is the formulation target, past transportation conditions, and KPI weights of actual transportation records; a calculation step, in which the KPI calculation portion 50 calculates KPI weights relative to the past transportation conditions by comparing the KPI values calculated on the basis of the transportation plan formulated by the transportation planning portion 30 with the KPI values of past actual transportation records calculated from the past actual transportation records; and a setting step, in which the KPI setting portion 40 identifies, from among a plurality of the past transportation conditions, the past transportation conditions with the highest similarity to the transportation conditions of the transportation plan, which is the formulation target, and sets the KPI weights of the actual transportation records corresponding to the identified past transportation conditions.

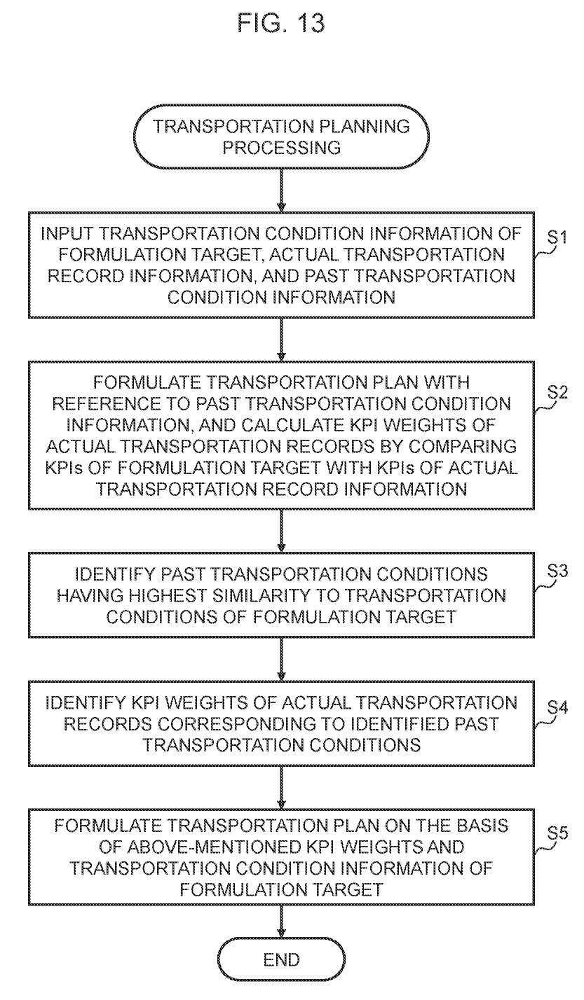

FIG. 13 is a flowchart showing an example of the procedure for transportation planning processing. In step S1, the transportation condition information 140 of the formulation target, the actual transportation record information 130, and the past transportation condition information 140 are input to the transportation planning apparatus 100.

In step S2, the KPI calculation portion 50 formulates a transportation plan with reference to the past transportation condition information, and calculates the KPI weights of the actual transportation records by comparing the KPIs of the formulation target with the KPIs of the actual transportation record information. In other words, the KPI calculation portion 50 inputs a plurality of the actual transportation records, and the past transportation conditions corresponding to each actual transportation record, and calculates KPI weights by comparing the KPIs of the transportation plan formulated on the basis of the past transportation conditions with the KPIs of the actual transportation records.

In step S3, the KPI setting portion 40 identifies the past transportation conditions with the highest similarity to the transportation conditions of the formulation target. In other words, the KPI setting portion 40 identifies the past transportation conditions with the highest similarity to the transportation conditions of the formulation target, and outputs the KPI weights corresponding to the identified conditions.

In step S4, the KPI setting portion 40 identifies the KPI weights of the actual transportation records corresponding to the past transportation conditions identified as described above.

In step S5, the transportation planning portion 30 formulates a transportation plan on the basis of the KPI weights and the transportation condition information of the formulation target.

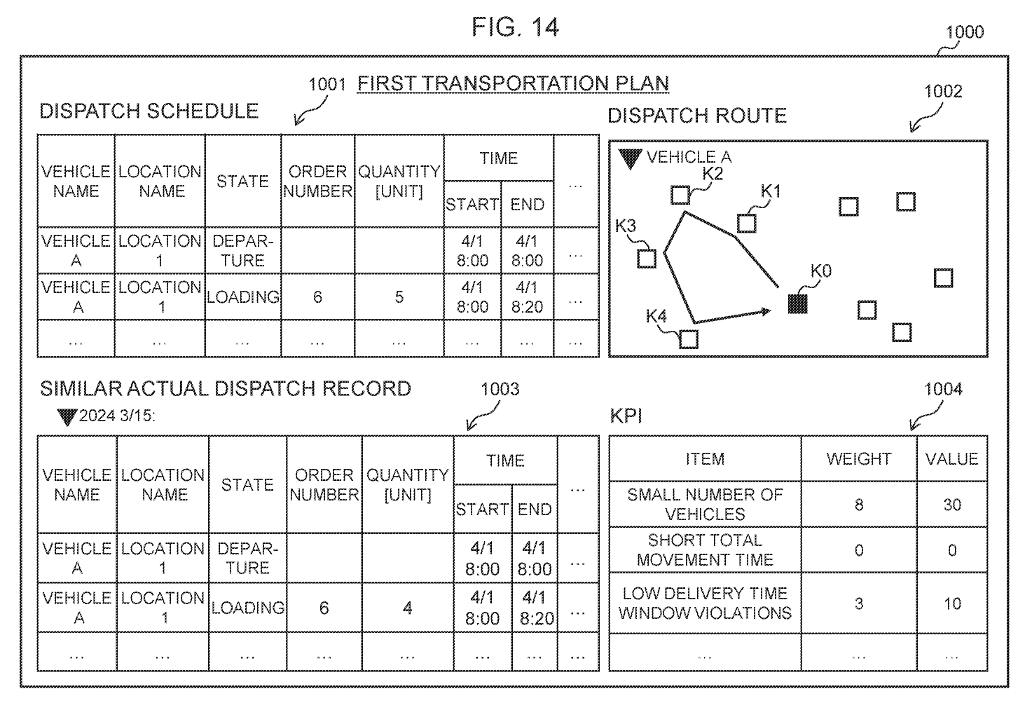

FIG. 14 is a diagram showing an example of a transportation plan output screen 1000 displayed on the display apparatus 25. The illustrated example is an output screen related to the transportation plan corresponding to the "first transportation plan".

In the transportation plan output screen 1000, a dispatch schedule display field 1001, a dispatch route display field 1002, a similar actual dispatch record display field 1003, and a KPI display field 1004 are provided.

In the dispatch schedule display field 1001, a dispatch schedule is displayed. In the dispatch route display field 1002, dispatch routes are displayed. The dispatch route starts from a base K0, named "Location 1", passes through bases K1 to K4, and returns to base K0.

In the similar actual dispatch record display field 1003, similar dispatch records are displayed. Similar actual dispatch record refers to past dispatch record similar to the targeted dispatch record. In the KPI display field 1004, KPIs are displayed.

The display apparatus 25, which is an example of an output apparatus, outputs the transportation plan formulated on the basis of the set KPI weights; the transportation conditions of the transportation plan, which is the formulation target; and the identified KPI weights.

The display apparatus 25 outputs the transportation plan formulated on the basis of the transportation conditions of the transportation plan, which is the formulation target, and the identified weights; the past actual transportation records corresponding to the transportation conditions with a high similarity to the transportation conditions of the transportation plan, which is the formulation target; and the KPI values calculated from the past actual transportation records.

As described above, the transportation planning system 1 including the transportation planning apparatus 100 according to the present embodiment includes: a transportation planning portion 30 that formulates a transportation plan on the basis of the transportation conditions of the transportation plan, which is the formulation target, the past transportation conditions, and the KPI (serving as an example of an important achievement evaluation indicator) weights of actual transportation records; a KPI calculation portion 50 (serving as an example of an indicator estimation portion) that calculates KPI weights relative to the past transportation conditions by comparing the KPI values calculated on the basis of the transportation plan formulated by the transportation planning portion 30 with the KPI values of past actual transportation records calculated from the past actual transportation records; and a KPI setting portion 40 (serving as an example of an indicator setting portion) that identifies, from among a plurality of the past transportation conditions, the past transportation conditions with the highest similarity to the transportation conditions of the transportation plan, which is the formulation target, and sets the KPI weights of the actual transportation records corresponding to the identified past transportation conditions.

The transportation planning method according to the present embodiment includes: a transportation planning step, in which the transportation planning portion 30 formulates a transportation plan on the basis of transportation conditions of the transportation plan, which is the formulation target, past transportation conditions, and KPI weights of actual transportation records; a calculation step, in which the KPI calculation portion 50 calculates KPI weights relative to the past transportation conditions by comparing the KPI values calculated on the basis of the transportation plan formulated by the transportation planning portion 30 with the KPI values of past actual transportation records calculated from the past actual transportation records; and a setting step, in which the KPI setting portion 40 identifies, from among a plurality of the past transportation conditions, the past transportation conditions with the highest similarity to the transportation conditions of the transportation plan, which is the formulation target, and sets the KPI weights of the actual transportation records corresponding to the identified past transportation conditions.

The transportation planning program according to the present embodiment executes the following steps on a computer: a transportation planning step, in which the above-mentioned transportation planning portion 30 is caused to formulate a transportation plan on the basis of transportation conditions of the transportation plan, which is the formulation target, past transportation conditions, and KPI weights of actual transportation records; a calculation step, in which the KPI calculation portion 50 is caused to calculate KPI weights relative to the past transportation conditions by comparing the KPI values calculated on the basis of the transportation plan formulated by the transportation planning portion 30 with the KPI values of past actual transportation records calculated from the past actual transportation records; and a setting step, in which the KPI setting portion 40 is caused to identify, from among a plurality of the past transportation conditions, the past transportation conditions with the highest similarity to the transportation conditions of the transportation plan, which is the formulation target, and set the weights of the important achievement evaluation indicators of the actual transportation records corresponding to the identified past transportation conditions.

In this way, it is possible to formulate a favorable transportation plan for transportation operators and transportation characteristics by achieving a balance (hereinafter referred to as "said balance") between reducing the number of required drivers and enhancing the QoW for drivers.

In the present embodiment, the transportation planning portion 30 formulates a transportation plan on the basis of the set KPI weights of the actual transportation records and the transportation conditions of the transportation plan, which is the formulation target. In this way, using these KPI weights of the actual transportation records and the transportation conditions, it is possible to formulate a favorable transportation plan for transportation operators and transportation characteristics by achieving said balance.

In the present embodiment, the transportation planning portion 30 extracts the transportation conditions of the transportation plan, which is the formulation target, and the past transportation conditions, from at least one of the following: the order information, the vehicle information, the driver information, and the base information. In this way, using these pieces of information, it is possible to formulate a favorable transportation plan for transportation operators and transportation characteristics by achieving said balance.

In the present embodiment, the KPI weights include at least one item from the following: minimization of the number of vehicles, minimization of the number of drivers, maximization of loading rate, minimization of pickup and delivery time window violations, minimization of working time window violations, leveling of drivers' working hours, leveling of the number of drivers' visits, and leveling of loading rate; and the corresponding weights of each of the above-mentioned at least one item. In this way, using the at least one item and the corresponding weight thereof, it is possible to formulate a favorable transportation plan for transportation operators and transportation characteristics by achieving said balance.

In the present embodiment, the KPI setting portion 40 estimates the past transportation conditions from the past actual transportation records. In this way, using the estimated past transportation conditions, it is possible to formulate a favorable transportation plan for transportation operators and transportation characteristics by achieving said balance.

In the present embodiment, the KPI setting portion 40 determines the similarity of the transportation conditions on the basis of at least one of the following: total number of orders, total order quantity, total order quantity relative to total vehicle loading capacity, length of order shipping time windows, length of order delivery time windows, distribution of order shipping time windows, distribution of order delivery time windows, length of order shipping time windows relative to length of vehicle operation time windows, length of order delivery time windows relative to length of vehicle operation time windows, length of order shipping time windows relative to length of time required for shipping work, length of order delivery time windows relative to length of time required for delivery work, number of vehicles, vehicle loadable capacity, length of vehicle operation time windows, distribution of vehicle operation time windows, number of drivers, length of driver working time windows, distribution of driver working time windows, number of bases, latitude and longitude of bases, distribution of bases, distance between bases, and inter-base movement time. In this way, according to the determined similarity of transportation conditions, it is possible to formulate a favorable transportation plan for transportation operators and transportation characteristics by achieving said balance.

The KPI calculation portion 50 identifies a plurality of the past transportation conditions with a high similarity to the transportation conditions of the transportation plan, which is the formulation target, and calculates, by performing statistical processing on the KPI weights of a plurality of the actual transportation records corresponding to the identified plurality of the past transportation conditions, the KPI weights of the transportation conditions of the transportation plan, which is the formulation target. In this way, using the calculated KPI weights, it is possible to formulate a favorable transportation plan for transportation operators and transportation characteristics by achieving said balance.

In the present embodiment, the display apparatus 25, which is an example of an output apparatus, outputs the transportation plan formulated on the basis of the set KPI weights; the transportation conditions of the transportation plan, which is the formulation target; and the identified KPI weights. In this way, using the set KPI weights, the transportation conditions of the transportation plan, which is the formulation target, and the identified KPI weights, it is possible to formulate a favorable transportation plan for transportation operators and transportation characteristics by achieving said balance.

In the present embodiment, the display apparatus 25 outputs the transportation plan formulated on the basis of the transportation conditions of the transportation plan, which is the formulation target, and the identified weights; the past actual transportation records corresponding to the transportation conditions with a high similarity to the transportation conditions of the transportation plan, which is the formulation target; and the KPI values calculated from the past actual transportation records. In this way, with reference to the output KPI values, it is possible to formulate a favorable transportation plan for transportation operators and transportation characteristics by achieving said balance.

Note that the present invention is not limited to the embodiments described above and includes many variations and equivalent configurations without departing from the gist of attached claims. For example, the above-described embodiments have been mentioned in detail to describe the present invention in an easy-to-understand manner, and the present invention is not necessarily limited to a configuration including all the described arrangements. In addition, the elements described in the present embodiment in parallel may be in a form in which at least one of the elements is connected in series with the other elements.

The present invention can be applied to a transportation planning apparatus related to a technique for formulating a transportation plan.

What is claimed is:

1. A transportation planning apparatus, comprising:
a transportation planning portion that formulates a transportation plan on the basis of transportation conditions of the transportation plan, which is a formulation target, past transportation conditions, and weights of the important achievement evaluation indicators of actual transportation records;
an indicator estimation portion that estimates weights of the important achievement evaluation indicators relative to the past transportation conditions by comparing values of the important achievement evaluation indicators calculated on the basis of the transportation plan formulated by the transportation planning portion with values of the important achievement evaluation indicators of past actual transportation records calculated from the past actual transportation records; and
an indicator setting portion that identifies, from among a plurality of the past transportation conditions, past transportation conditions with the highest similarity to the transportation conditions of the transportation plan, which is the formulation target, and sets the weights of the important achievement evaluation indicators of the actual transportation records corresponding to the identified past transportation conditions.

2. The transportation planning apparatus according to claim 1, wherein
the transportation planning portion formulates a transportation plan on the basis of the set weights of the important achievement evaluation indicators of the actual transportation records and the transportation conditions of the transportation plan, which is the formulation target.

3. The transportation planning apparatus according to claim 1, wherein
the transportation planning portion extracts the transportation conditions of the transportation plan, which is the formulation target, and the past transportation conditions, from at least one of: order information, vehicle information, driver information, and base information.

4. The transportation planning apparatus according to claim 1, wherein
the weights of the important achievement evaluation indicators include at least one of following items: minimization of the number of vehicles, minimization of the number of drivers, maximization of loading rate, minimization of pickup and delivery time window violations, minimization of working time window violations, leveling of driver working hours, leveling of the number of driver visits, and leveling of loading rate; and the corresponding weights of at least one of the items.

5. The transportation planning apparatus according to claim 1, wherein
the indicator setting portion estimates the past transportation conditions from the past actual transportation records.

6. The transportation planning apparatus according to claim 1, wherein
the indicator setting portion determines the similarity of the transportation conditions on the basis of at least one of: total number of orders, total order quantity, total order quantity relative to total vehicle loading capacity, length of order shipping time windows, length of order delivery time windows, distribution of order shipping time windows, distribution of order delivery time windows, length of order shipping time windows relative to length of vehicle operation time windows, length of order delivery time windows relative to length of vehicle operation time windows, length of order shipping time windows relative to length of time required for shipping work, length of order delivery time windows relative to length of time required for delivery work, number of vehicles, vehicle loadable capacity, length of vehicle operation time windows, distribution of vehicle operation time windows, number of drivers, length of driver working time windows, distribution of driver working time windows, number of bases, latitude and longitude of bases, distribution of bases, distance between bases, and inter-base movement time.

7. The transportation planning apparatus according to claim 1, wherein
the indicator estimation portion identifies a plurality of the past transportation conditions with a high similarity to the transportation conditions of the transportation plan, which is the formulation target, and calculates, by performing statistical processing on the weights of the important achievement evaluation indicators of a plurality of the actual transportation records corresponding to the plurality of identified past transportation conditions, the weights of the important achievement evaluation indicators of the transportation conditions of the transportation plan, which is the formulation target.

8. The transportation planning apparatus according to claim 1, further comprising an output apparatus that outputs the transportation plan formulated on the basis of the set weights of the important achievement evaluation indicators; the transportation conditions of the transportation plan, which is the formulation target; and the identified weights of the important achievement evaluation indicators.

9. The transportation planning apparatus according to claim 1, further comprising an output apparatus that outputs
the transportation plan formulated on the basis of the transportation conditions of the transportation plan, which is the formulation target, and the identified weights;
the past actual transportation records corresponding to the transportation conditions with a high similarity to the transportation conditions of the transportation plan, which is the formulation target; and
the values of the important achievement evaluation indicators calculated from the past actual transportation records.

10. A transportation planning method comprising:
a transportation planning step, in which a transportation planning portion formulates a transportation plan on the basis of transportation conditions of the transportation plan, which is a formulation target, past transportation conditions, and weights of important achievement evaluation indicators of actual transportation records;
a calculation step, in which an indicator estimation portion calculates weights of the important achievement evaluation indicators relative to the past transportation conditions by comparing values of the important achievement evaluation indicators calculated on the basis of the transportation plan formulated by the transportation planning portion with values of the important achievement evaluation indicators of past actual transportation records calculated from the past actual transportation records; and
a setting step, in which an indicator setting portion identifies, from among a plurality of the past transportation conditions, past transportation conditions with the highest similarity to the transportation conditions of the transportation plan, which is the formulation target, and sets the weights of the important achievement evaluation indicators of the actual transportation records corresponding to the identified past transportation conditions.

11. A non-transitory computer-readable recording medium having recorded therein a computer program for causing a computer to execute:
formulating a transportation plan on the basis of transportation conditions of the transportation plan, which is a formulation target, past transportation conditions, and weights of important achievement evaluation indicators of actual transportation records;
calculating weights of the important achievement evaluation indicators relative to the past transportation conditions by comparing values of the important achievement evaluation indicators calculated on the basis of the transportation plan formulated by a transportation planning portion with values of the important achievement evaluation indicators of past actual transportation records calculated from the past actual transportation records; and
identifying, from among a plurality of the past transportation conditions, past transportation conditions with the highest similarity to the transportation conditions of the transportation plan, which is the formulation target, and setting the weights of the important achievement evaluation indicators of the actual transportation records corresponding to the identified past transportation conditions.
